(19) United States
(12) Patent Application Publication
(10) Pub. No.: US 2023/0092190 A1
(43) Pub. Date: Mar. 23, 2023

(54) TWO-LAYER SIDE-CHANNEL ATTACKS DETECTION METHOD AND DEVICES

(71) Applicant: The Regents of the University of California, Oakland, CA (US)

(72) Inventors: Houman Homayoun, San Jose, CA (US); Prasant Mohapatra, Davis, CA (US); Han Wang, Davis, CA (US); Setareh Rafatirad, San Jose, CA (US)

(73) Assignee: The Regents of the University of California, Oakland, CA (US)

(21) Appl. No.: 17/482,083

(22) Filed: Sep. 22, 2021

(51) Int. Cl. G06F 21/55; G06F 21/54; G06K 9/62; G06N 20/00

(52) U.S. Cl. CPC G06F 21/554; G06F 21/556; G06F 21/54; G06K 9/6256; G06N 20/00

(57) ABSTRACT

The embodiments disclose a system and method including a side-channel attack detection framework comprising a data detector and a distribution detector configured for detecting known and unknown side-channel attack on a user's computer, a data detector configured for constantly monitoring the user's computer microarchitectural features activities in real-time, wherein the data detector includes a machine learning-based classification system and a distribution detector data distribution model configured for detecting both known and unknown emerging side-channel attacks in real-time.

### BACKGROUND

Microarchitectural Side-Channel Attacks (SCAs) have posed serious threats to the security of modern computing systems. Such attacks exploit side-channel vulnerabilities stemming from fundamental performance-enhancing components such as cache memories. The existing works on detection of SCAs based on low-level micro-architectural features have considered collecting both user and attack applications' hardware events that are captured from processors' hardware performance counter (HPC) registers. However, the drawbacks of such techniques can greatly impact effectiveness. The attack HPCs data can be easily manipulated and/or corrupted resulting in misleading the SCA detection mechanism. Secondly, prior real-time detectors are biased to the “attack” class. Lastly, they heavily rely on the knowledge of attacks and are incapable of capturing zero-day attacks while the prior works have only examined the instance-level false alarm rate.

### BRIEF DESCRIPTION OF THE DRAWINGS

FIG. 1A shows for illustrative purposes only an example of an overview of a two-layer machine learning-based real-time SCAs scanning and zero-day threats detection framework of one embodiment.

FIG. 1B shows a block diagram of an overview flow chart of a two-layer machine learning-based real-time SCAs detection framework of one embodiment.

FIG. 2A shows for illustrative purposes only an example of a first layer detector of one embodiment.

FIG. 2B shows for illustrative purposes only an example of a second layer detector of one embodiment.

FIG. 3 shows for illustrative purposes only an example of LLC Misses of one embodiment.

FIG. 4 shows for illustrative purposes only an example of various ML classifiers prediction accuracy of one embodiment.

FIG. 5 shows for illustrative purposes only an example of a decision delay illustration of one embodiment.

FIG. 6 shows for illustrative purposes only an example of a false alarm problem of one embodiment.

FIG. 7 shows for illustrative purposes only an example of a first-layer real-time SCAs detector of one embodiment.

FIG. 8 shows for illustrative purposes only an example of a second-layer real-time SCAs detector of one embodiment.

FIG. 9 shows for illustrative purposes only an example of a t-SNE plot for a user under no attack and a user under known attacks of one embodiment.

FIG. 10 shows for illustrative purposes only an example of a t-SNE plot with the desired classifying line for a user under no attack, known attack, and unknown attack samples of one embodiment.

FIG. 11 shows for illustrative purposes only an example of different threshold influences of one embodiment.

FIG. 12 shows for illustrative purposes only an example of data distribution, Gaussian distribution, and Poisson distribution of various HPCs temporal traces of one embodiment.

FIG. 13 shows for illustrative purposes only an example of Table 13: False Positive and False Negative Evaluation of one embodiment.

FIG. 14 shows a block diagram of an overview of theoretical false-positive rates of one embodiment.

### DETAILED DESCRIPTION OF THE INVENTION

In the following description, reference is made to the accompanying drawings, which form a part hereof, and in which is shown by way of illustration a specific example in which the invention may be practiced. It is to be understood that other embodiments may be utilized, and structural changes may be made without departing from the scope of the present invention.

### General Overview

It should be noted that the descriptions that follow, for example, in terms of a two-layer side-channel attacks detection method and devices are described for illustrative purposes and the underlying system can apply to any number and multiple types of computing devices and systems. Complex computer programming can include a potentially serious software security weakness unrecognized by the program developer. An unrecognized potentially serious software security weakness is susceptible to cryptosystems side-channel attacks and is referred to as a zero-day attack.

In one embodiment of the present invention, the two-layer side-channel attacks detection method and devices can be configured using at least one hardware performance counter (HPC). The two-layer side-channel attacks detection method and devices can be configured to include a first layer detector and can be configured to include a second layer using the present invention.

A side-channel attack is any attack based on information gained from the implementation of a computer system, rather than weaknesses in the implemented algorithm itself. Side-Channel Attacks (SCAs) are very sophisticated reverse engineering attacks on computer cryptosystems. Side Channel attacks use measurements of differences in computer physical processes such as power consumption and heat dissipation to extract the secret information of the cryptographic algorithms such as an encryption key. Side-channel attacks are attempts to uncover secret information based on the physical property of a cryptosystem, rather than exploiting the theoretical weaknesses in the implemented cryptographic algorithm.

Power analysis attacks begin with precisely measuring the power consumption of the target device many times. Depending on the secret key used in the algorithm, the power consumption of an unprotected implementation shows a unique power consumption profile. By matching the profile against the power profiles predicted with every possible key, the secret key can be deduced without accessing the data in the system. Side-channel attacks typically target the computer hardware causing interference in the cache memory and then observing cache accessing patterns or intentionally manipulating branch predictor's functions and accessing sensitive memory addresses illegally.

Microarchitectural Side-Channel Attacks (SCAs) have posed serious threats to the security of modern computing systems. Such attacks exploit side-channel vulnerabilities stemming from fundamental performance-enhancing components such as cache memories.

The terms “two-layer machine learning-based real-time SCAs scanning and zero-day threats detection framework”, “two-layer SCA detection framework”, “two-layer side-channel attack detection framework”, “two-layer machine learning-based real-time SCAs detection framework”, and “two-layer detector” are used interchangeably herein without any change in meaning.

The terms “first-layer detector”, “first layer detector”, “data detector”, and “1^{st} layer detector” are used interchangeably herein without any change in meaning.

The terms “second-layer detector”, “second layer detector”, “distribution detector”, and “2^{nd} layer detector” are used interchangeably herein without any change in meaning.

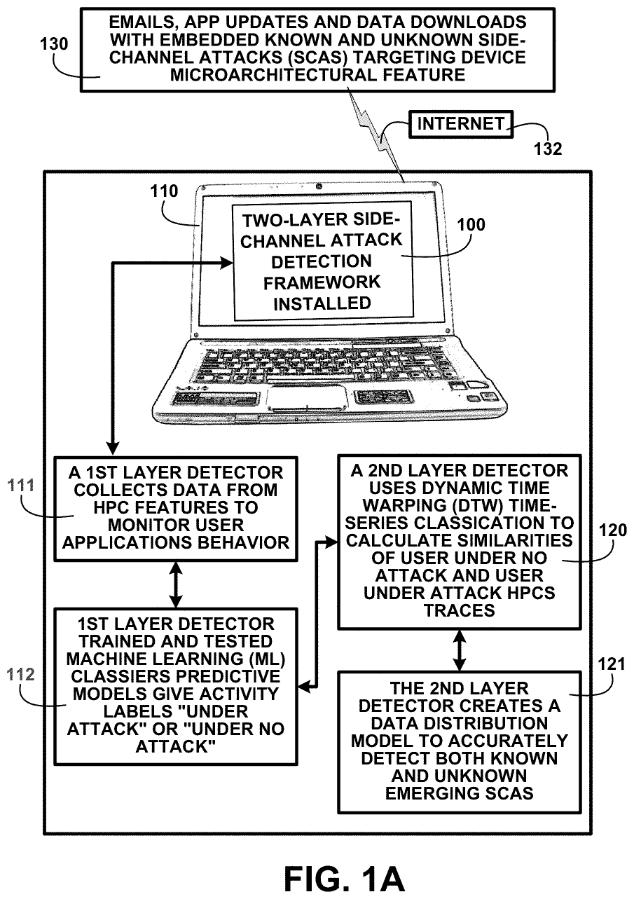

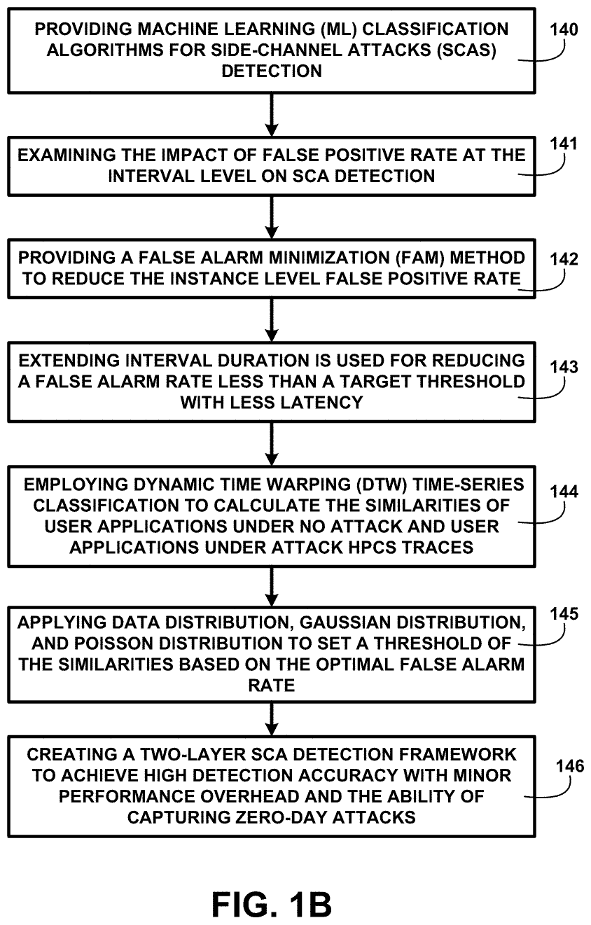

FIG. 1A shows for illustrative purposes only an example of an overview of a two-layer machine learning-based real-time SCAs scanning and zero-day threats detection framework of one embodiment. FIG. 1A shows for example a user computer 110 with a two-layer side-channel attack detection framework installed 100 connected to the internet 132. The SCA attacks can come with internet 132 emails, app updates, and data downloads with embedded known and unknown side-channel attacks (SCAs) targeting device microarchitectural feature 130 of the user computer 110.

The entry into the computer through emails, app updates, and data downloads further complicates the threat. Many computer users opt for automatic updates of apps. The automatic app updates are generally performed in the background in many cases with the user unaware that they are taking place. Some users have become cautious when seeing emails from a sender the user does not recognize and deletes without opening. But side-channel attackers can disguise an email to appear as a legitimate sender. When the user opens the email the embedded SCA is downloaded into the computer. Data downloads also can include SCAs embedded into the data at the legitimate source without the source being aware. When a user downloads the data the embedded SCA is downloaded into the user's computer without any idea that the data is infected with the SCA.

The two-layer side-channel attack detection framework comprises a 1st layer detector and a 2nd layer detector. The two-layer side-channel attack detection framework installed 100 is constantly monitoring the user computer 110 microarchitectural features activities. Part of the microarchitectural features is processors' hardware performance counter (HPC) registers. The 1st layer detector collects data from HPC features to monitor user applications' behavior 111. The 1st layer detector trained and tested machine learning (ML) classifier predictive models give activity labels “under attack” or “under no attack” 112. The first layer detector machine learning (ML) based classification system is leveraged to detect SCAs in real-time.

The 1st layer detector trained and tested machine learning (ML) classifiers predictive models monitor the computer hardware to identify if any microarchitectural features activities are outside the normal activity levels. Because side-channel attacks typically target the computer hardware the 1st layer detector (ML) classifiers predictive models continuous real-time monitoring are able to detect SCA measurements of differences in computer physical processes such as power consumption and heat dissipation. These interferences in normal activities are detectable and indicate an attack may be occurring.

The 2nd layer detector uses dynamic time warping (DTW) time-series classification to calculate similarities of the user hardware under no attack and the user hardware under attack HPCs traces 120. The 2nd layer detector creates a data distribution model to accurately detect both known and unknown emerging SCAs 121. The HPCs traces data distribution models indicate accurately the probability of one or more SCA and zero-day attack activities of one embodiment.

FIG. 1B shows a block diagram of an overview flow chart of a two-layer machine learning-based real-time SCAs detection framework of one embodiment. FIG. 1B shows the two-layer side-channel attack detection framework is a viable cybersecurity protection system against side-channel attacks.

Organizations that depend on encryption using computer cryptosystems to safeguard private information and secret data are targets for side-channel attacks. The two-layer side-channel attack detection framework provides protection against both known and unknown emerging side-channel attacks by providing machine learning (ML) classification algorithms for side-channel attacks (SCAs) detection 140.

The two-layer side-channel attack detection framework is examining the impact of the false-positive rate at the interval level on SCA detection 141. A false-positive is an incorrect determination that a SCA is attacking. Although a low false-positive occurrence is acceptable, a reduction in the false-positive determinations prevents a high false alarm rate.

The two-layer side-channel attack detection framework is providing a false alarm minimization (FAM) method to reduce the instance level false positive rate 142. False Alarm Minimization-FAM real-time detection methods are biased to the attack category. The two-layer machine learning-based real-time SCAs detection framework includes measures to balance the bias. The instance-level false positives are evaluated and reduced while maintaining high detection accuracy with determining a delay of the attack decision to solve the risk of a high false alarm rate. Delaying the attack decision means the detection system only reports an attack when consecutive N intervals are identified as “under attack”.

In one embodiment, extending interval duration is used for reducing a false alarm rate to less than an acceptable target threshold with less latency 143. Latency is the delay before a transfer of data begins following an instruction for its transfer.

Reducing a false alarm rate in part is accomplished with employing dynamic time warping (DTW) time-series classification to calculate the similarities of user applications under no attack and user applications under attack HPCs traces 144. This further reduces a false alarm rate. Applying data distribution, Gaussian distribution, and Poisson distribution to set a threshold of the HPCs traces similarities based on the optimal false alarm rate 145 increases accuracy.

FAM real-time detection is a part of creating a two-layer SCA detection framework to achieve high detection accuracy with a minor performance overhead and the ability to capture zero-day attacks 146. If the prediction result is “under attack”, users will be alarmed and a mitigation strategy can be activated to protect the user data and applications and remove the SCAs. Under attack alarms include computer displays and audio signals. Under attack alarms also include text messages to a user's digital device for example a smart phone and emails WIFI and internet transmissions of one embodiment.

### Detailed Description

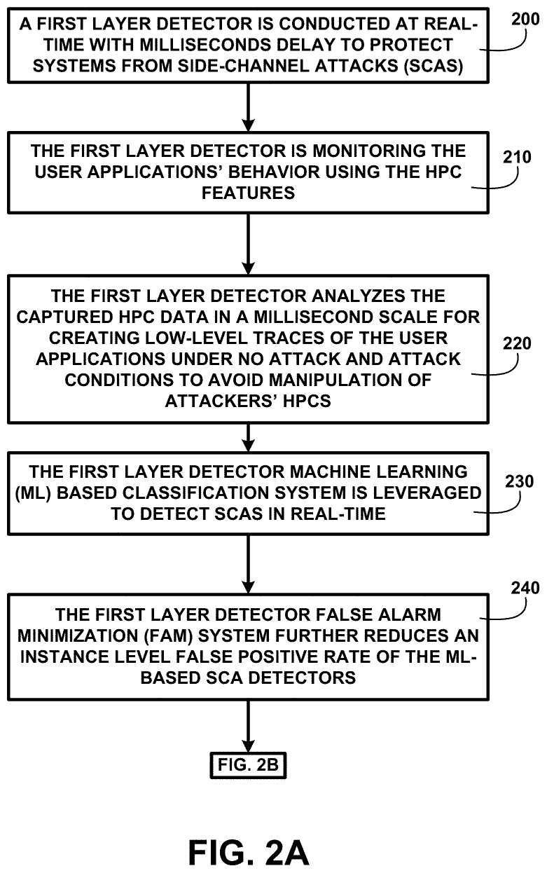

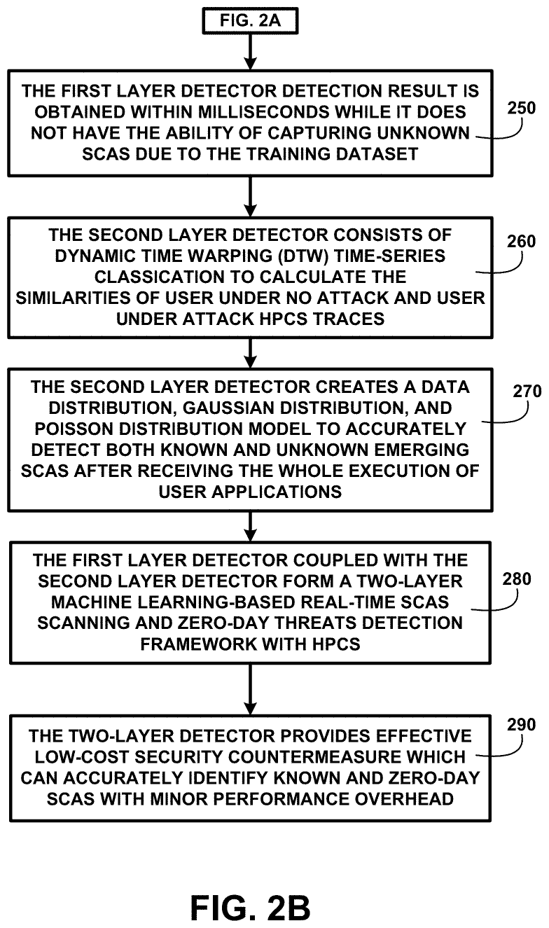

FIG. 2A shows for illustrative purposes only an example of a first layer detector of one embodiment. FIG. 2A shows a first layer detector is conducted in real-time with milliseconds delay to protect systems from side-channel attacks (SCAs) 200. The first layer detector is monitoring the user applications' behavior using the HPC features 210. The first layer detector analyzes the captured HPC data in a millisecond scale for creating low-level traces of the user applications under no attack and attack conditions to avoid manipulation of attackers' HPCs 220. The first layer detector machine learning (ML) based classification system is leveraged to detect SCAs in real-time 230. The first layer detector false alarm minimization (FAM) system further reduces an instance-level false positive rate of the ML-based SCA detectors 240. The descriptions continue on FIG. 2B.

### A Second Layer Detector

FIG. 2B shows for illustrative purposes only an example of a second layer detector of one embodiment. FIG. 2B shows a continuation from FIG. 2A where the first layer detector detection result is obtained within milliseconds while it does not have the ability to capture unknown SCAs due to the training dataset 250. The second layer detector consists of dynamic time warping (DTW) time-series classification to calculate the similarities of a user under no attack and user under attack HPCs traces 260.

DTW determines the best alignment that will produce the optimal distance and classifies data according to the calculated distance between time-series subsequences. The distance calculation method employs shaped-based similarities of subsequences. A user application HPC under attack shows a significantly different trend compared to that of user application HPC under no attack. This highlights the effectiveness of using user application HPCs significantly different trends data for DTW time-series classification to calculate the similarities of a user under no attack and user under attack HPCs traces.

For example accessing time of the cache sets, which changes caching users' data and microarchitectural behaviors of user applications is significantly different when under SCA attack. The difference is measurable when the second layer detector creates a data distribution, Gaussian distribution, and Poisson distribution models to accurately detect both known and unknown emerging SCAs after receiving the whole execution of user applications 270. This provides the opportunity of detecting SCAs by observing the alteration in microarchitectural behaviors.

The first layer detector coupled with the second layer detector form a two-layer machine learning-based real-time SCAs scanning and zero-day threats detection framework with HPCs 280. The two-layer detector provides an effective low-cost security countermeasure which can accurately identify known and zero-day SCAs with a minor performance overhead 290 of one embodiment.

### LLC Misses

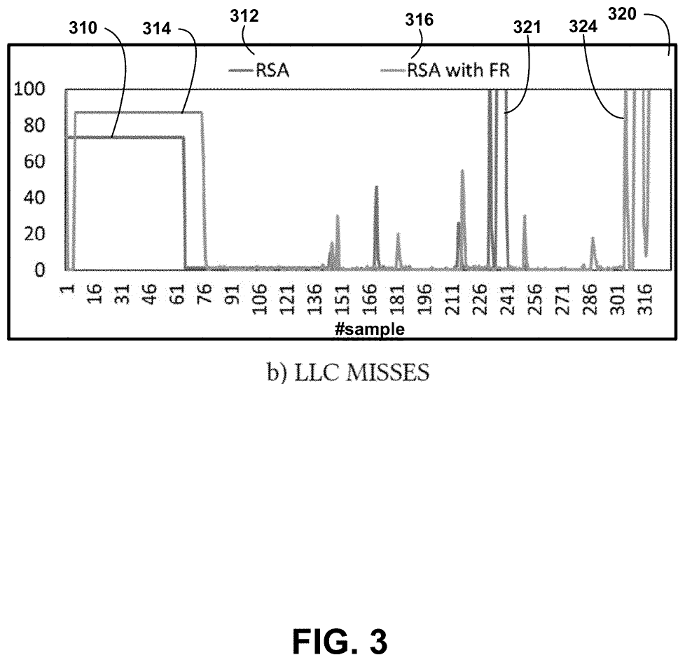

FIG. 3 shows for illustrative purposes only an example of LLC Misses of one embodiment. FIG. 3 shows a Last-Level Cache (LLC) Misses graph 320 hardware performance counters (HPCs) registers built-in modern microprocessors counts of in this example of hardware-related events such as cache misses suffered. A computer controller performs cache flushing when the amount of unwritten data in the cache reaches a certain level, the controller periodically writes cached data to a drive. This writing process is called “flushing.” The controller uses two algorithms for flushing cache: demand-based and age-based.

Some SCAs attack targets in the Last-Level Cache (L3) in the CPU and flushes out user applications' data in the cache and waits for the user execution. Then the SCA attacker reloads data by accessing them and measures the accessing time. If accessing time is shorter, then data has been accessed by the user application, if the accessing time is longer then it has not been accessed by the user application. In this type of SCA attack, the inclusiveness of an L3 cache, the attack program, and the user application do not need to share the execution core.

In another type of SCA, the attack does not make any memory accesses and relies on the execution time of the flush instruction. The execution time depends on whether the data is stored in the cache indicating the data is accessed by user applications. If the time of flushing is longer, it means corresponding data is accessed by the user application.

In another type of SCA, the attack targets more than one data cache. In this SCA, the attacker builds an eviction set which is a group of cache sets causing potential conflict with user applications and fills the cache with the eviction sets. Next, the attacker waits for the execution of the user application and then re-accesses the eviction sets. If the accessing time is long enough, it means the user application has accessed the data; else, the user application does not access the data.

As a result of the different attack approaches the microarchitectural events related to cache memory and branch predictor units can better reflect the influence of the side-channel attacks on the underlying micro-architecture. In addition, since the cache and branch predictor influence can alter instructions execution, the instructions retired and micro-operations retired events are top features for detection.

The LLC Misses graph 320 shows the tested user application (RSA) 312 and for example the attack application (L3 Flush Reload) 316 is illustrated. It can be observed that LLC misses of user application under attack 314 shown as spikes 324 show significantly different trends compared to that of user application under no attack 310 spikes 321 of one embodiment.

### Various ML Classifiers Prediction Accuracy

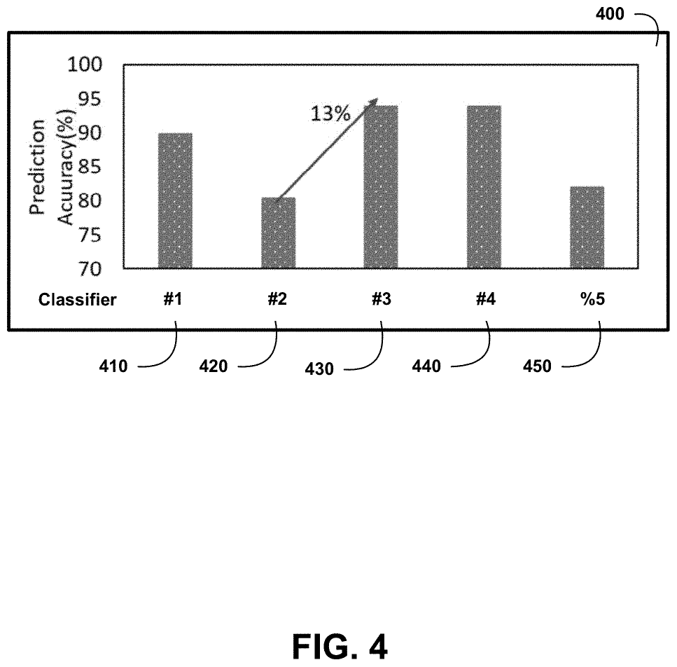

FIG. 4 shows for illustrative purposes only an example of various ML classifiers prediction accuracy of one embodiment. FIG. 4 shows an example of various ML classifiers' prediction accuracy for Flush-Reload bar chart 400. The various ML classifiers include #1 410, #2 420, #3 430, #4 440, and #5 450. Prediction of the SCA detection results between the various ML classifiers varies significantly.

For example between five classifiers, each has very different prediction accuracy, ranging from 80% to 93%. Training classification models and then testing the classification models using the collected data for training and testing classifiers. For the purpose of a thorough analysis of various types of machine learning classifiers, the prediction accuracy of different classifiers can vary a lot for attack detection.

For example, different SCA attacks are analyzed with five classification techniques. This highlights the importance of exploring various classification algorithms in order to achieve high detection accuracy of the prediction accuracy of various classifiers.

SCA attackers utilize the non-deterministic and over-counting problems of instructions associated with HPCs information, in which the attackers can intentionally modify instructions slightly and manipulate the counters, hence thwarting detection. However, SCA attackers' HPCs are easily manipulated and not reliable. This provides the opportunity of detecting SCAs by observing the alteration in microarchitectural behaviors of one embodiment.

### A Decision Delay Illustration

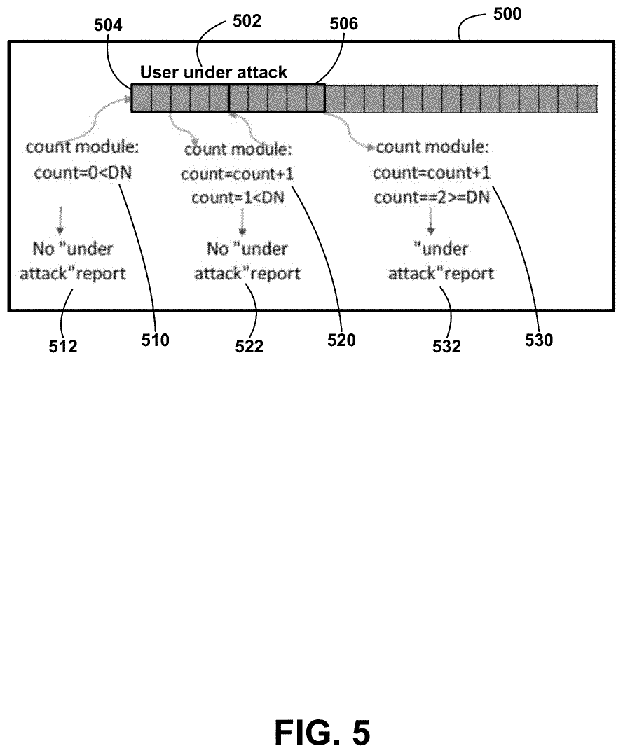

FIG. 5 shows for illustrative purposes only an example of a decision delay illustration of one embodiment. FIG. 5 shows a decision delay illustration 500 of a user under attack 502. The instance has a first count module 504 and a second count module 506. The HPC counter starts with a count module: count=0<DN 510, where DN denotes a “delay number”. A count=0 result generates no “under attack” report 512. A first count module: count=count+1 count=1≤DN 520 generates a first count module: no “under attack” report 522. A second count module: count=count+1 count=2>=DN 530 generates a second count module: “under attack” report 532 of one embodiment.

Real-time detection methods are biased to the attack category. False Alarm Minimization (FAM) consists of measures to balance the bias and instance-level false positives to be evaluated and reduced while maintaining high detection accuracy. In one embodiment, delaying the attack decision solves the risk of a high false alarm rate. False positives are evenly distributed among each instance, which has the highest false alarm rate with the same false-positive rate. Reducing the false alarm rate to an acceptable value will reduce the false alarm rate of the detection system to no greater than the value.

The first layer detector is conducted in real-time with milliseconds delay to protect systems. The first layer detector only monitors the user applications' behavior using the HPC features and analyzes the captured data every 10 milliseconds of low-level traces of the user applications under no attack and attack conditions to avoid manipulation of attackers' HPCs. Next, machine learning-based classification is leveraged to detect SCAs in real-time. Lastly, the False Alarm Minimization (FAM) technique is used to further reduce the instance level false positive rate of the ML-based SCA detectors.

The first layer detector receives user applications' HPCs data every sampling interval and reports prediction results for each sampled data record. If the prediction result is “under attack”, users will be alarmed and a mitigation strategy can be activated. If it is “normal”, then sampling continues along with the execution of user applications and the real-time detection process will repeat until the end of user execution. In this first layer, the detection result can be obtained within milliseconds while it does not have the ability to capture unknown SCAs due to the training dataset.

After the whole execution of user applications is complete, the HPCs data will be sent to the second layer detector, which is equipped with the SCA and zero-day SCAs detection ability. The second layer detector consists of Dynamic Time Warping (DTW) followed by a Gaussian distribution model to accurately detect both known and unknown emerging SCAs after receiving the whole execution of user applications of one embodiment.

### A False Alarm Problem

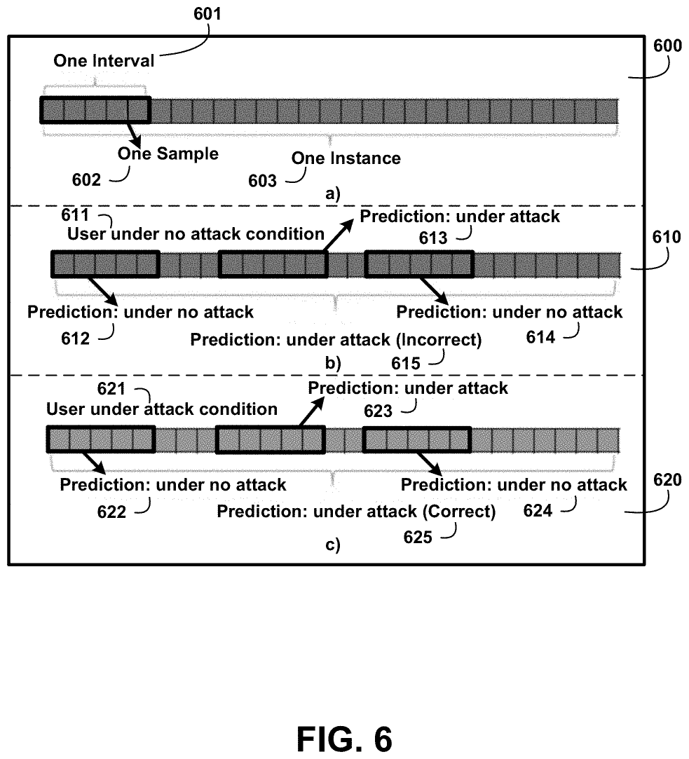

FIG. 6 shows for illustrative purposes only an example of a false alarm problem of one embodiment. FIG. 6 shows a false alarm prediction concept a) 600 showing the prediction increments of one interval 601, one sample 602, and one instance 603. The first false alarm problem is illustrated in a user under no attack condition b) 610. In this example, there is a user under no attack condition 611. A first interval sample prediction: under no attack 612 is followed by a second interval sample prediction: under attack 613 and followed by a third interval sample prediction: under no attack 614. The user under no attack condition 611 prediction: under attack (incorrect) 615 is a false alarm.

The second false alarm problem is illustrated in a second user under attack condition c) 620. In this example, there is a user under attack condition 621. A first interval sample prediction: under no attack 622 is followed by a second interval sample prediction: under attack 623, and a third interval sample prediction: under no attack 624. In this example, a prediction: under attack (correct) 625 is not a false alarm of one embodiment. As depicted in FIG. 3-(a), each run of a user application is called an instance.

For real-time SCA detection, a certain window size is used to decide the number of samples an interval has. Each instance could contain multiple intervals. In addition, a user application under no attack instance is divided into multiple intervals. In such cases, even if only one interval is predicted as “under attack” by the machine learning-based detection technique, the whole instance will be classified incorrectly as “under attack”. At the same time that the user application under attack instance has two intervals classified as “under no attack” and one interval classified as “under attack”, the whole instance is still correctly classified as “under attack”.

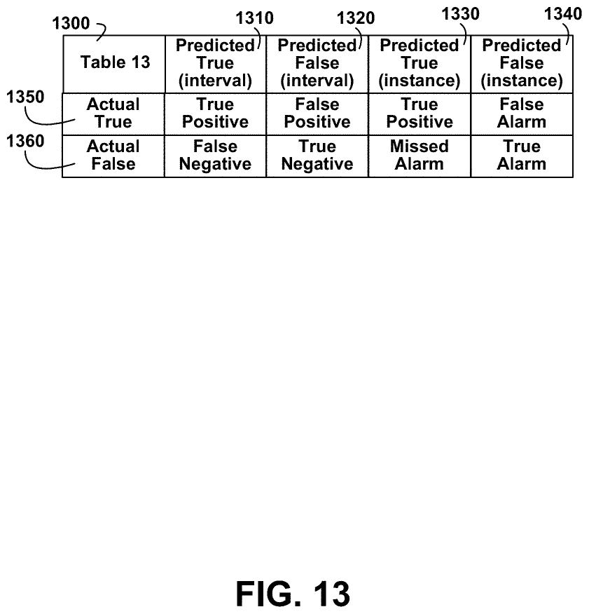

To distinguish false positives of interval level and instance level, a false alarm and missed alarm to represent false positive and false negative of instance-level as shown in FIG. 13. An interval level results to estimate the highest value of false alarm rate once classifiers are trained. Suppose the number of intervals of an instance is N, the false positive rate is m %. The highest false alarm rate is when false positives are distributed evenly and FAR represents a false alarm rate. As a result, the highest possible false alarm rate is FAR=(n−m+1)*(s%)Am<t where delay number=m, the number of intervals per instance=n, false-positive rate=s and acceptable false alarm rate is t delaying “under attack” decision until several consecutive intervals are predicted as “under attack”, gaining more confidence before reporting “under attack” of one embodiment.

### A First Layer Real-Time SCAs Detector

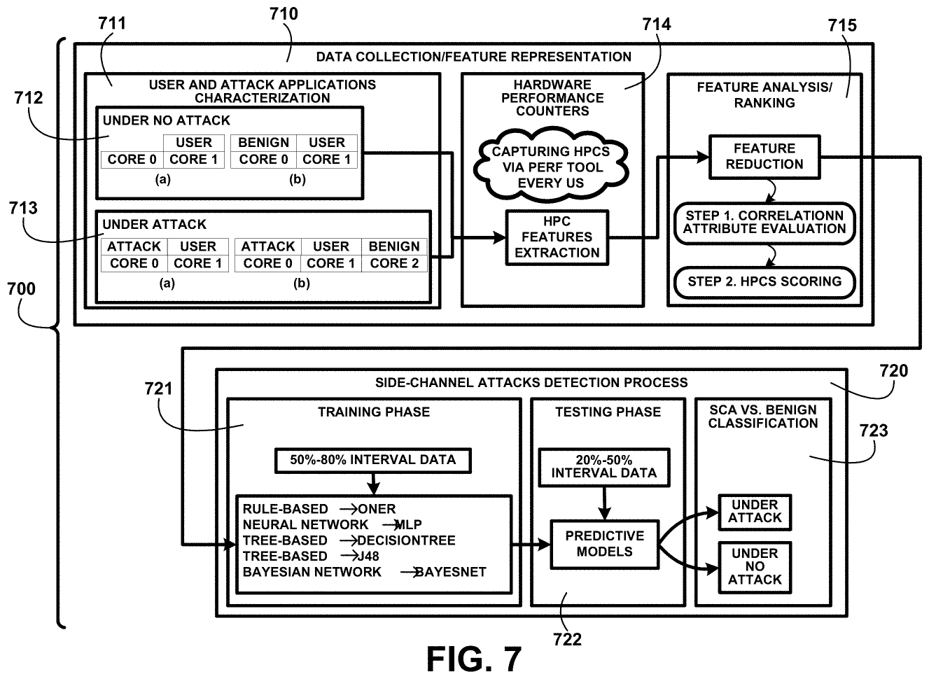

FIG. 7 shows for illustrative purposes only an example of a first-layer real-time SCAs detector of one embodiment. FIG. 7 shows a first-layer real-time SCAs detector 700. The first layer real-time SCAs detector has two sections consisting of data collection/feature representation 710 and side-channel attacks detection process 720.

The data collection/feature representation 710 includes user and attack applications characterization 711, under no attack 712, under attack 713. The data collection/feature representation 710 includes hardware performance counters 714 with feature analysis/ranking 715. Hardware performance counters 714 include capture HPC features extraction. Feature analysis/ranking 715 includes feature reduction with step 1. To correlate attribute evaluation and step 2. HPCs scoring.

The side-channel attacks detection process 720 section includes a training phase 721 using 50% to 80% interval data for various types of machine learning classifiers including rule-based, neutral network, tree-based, and Bayesian network. A testing phase 722 using 20% to 50% interval data is applied to predictive models for SCA vs. Benign Classification 723 under attack and under no attack for one embodiment.

### Second Layer Real-Time SCAS Detector

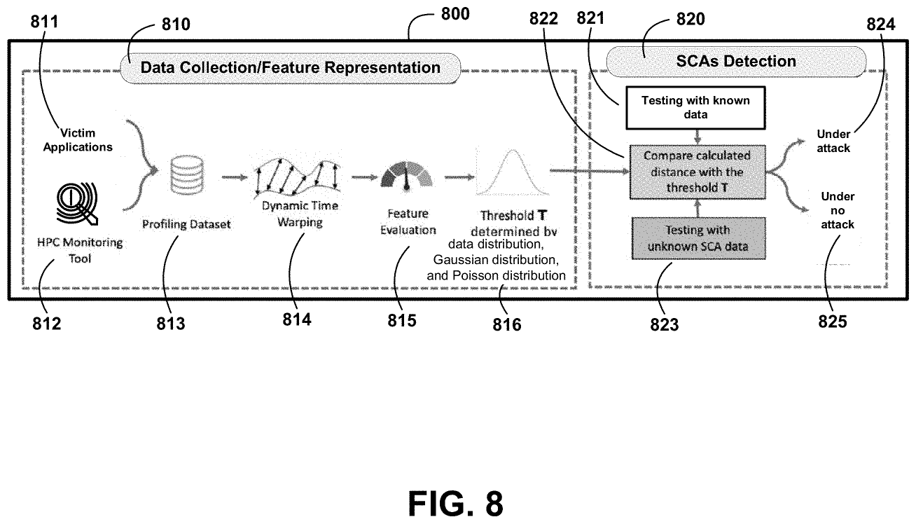

FIG. 8 shows for illustrative purposes only an example of a Second layer real-time SCAs detector of one embodiment. FIG. 8 shows a second-layer real-time SCAs detector 800. The second layer real-time SCAs detector 800 has two sections data collection/feature representation 810 and SCAs detection 820. The data collection/feature representation 810 sections include user applications 811, HPC monitoring tool 812, profiling dataset 813, dynamic time warping 814, feature evaluation 815, and threshold T determined by data distribution, Gaussian distribution, and Poisson distribution 816. The SCAs detection 820 section includes testing with known data 821, compare the calculated distance with the threshold T 822, testing with unknown SCA data 823, under attack 824, and under no attack 825 of one embodiment. After the whole execution of user applications, the HPCs data will be sent to the second layer detector, which is equipped with zero-day SCAs detection ability.

The second layer detector employs DTW time-series classification to calculate the similarities of a user under no attack and user under attack HPCs traces and then apply data distribution, Gaussian distribution, and Poisson distribution to set a threshold of the similarities based on the optimal false alarm rate. The second layer detector consists of Dynamic Time Warping (DTW) followed by data distribution, Gaussian distribution, and Poisson distribution models to accurately detect both known and unknown zero-day emerging SCAs after receiving the whole execution of user applications. One HPC sample is collected in millisecond scale for first layer SCAs detection and all sampled HPCs dataset forms a temporal sequence of the second layer SCAs detection of one embodiment.

To eliminate the influence of missing attack profiling data or tweaks in the attack applications codes, this work proposes a unified and efficient ML-based SCAs detection methodology based on differentiating HPCs data of only the user applications under two conditions: 1) user applications under attack, and 2) user applications under no attack. Various ML classification algorithms are explored to find the most suitable one for SCAs detection in terms of detection accuracy and incurred overhead.

The impact of false-positive rate at the interval level on SCA detection is reduced using a false alarm minimization (FAM) method to reduce the instance level false positive rate. The false alarm minimization (FAM) method extends interval duration. The extended interval duration can guarantee a false alarm rate less than a target threshold with less latency. It employs DTW time-series classification to calculate the similarities of the user under no attack and user under attack HPCs traces and then applies Gaussian distribution to set a threshold of the similarities based on the optimal false alarm rate of one embodiment.

### t-SNE Plot for a User Under No Attack and a User Under Known Attacks

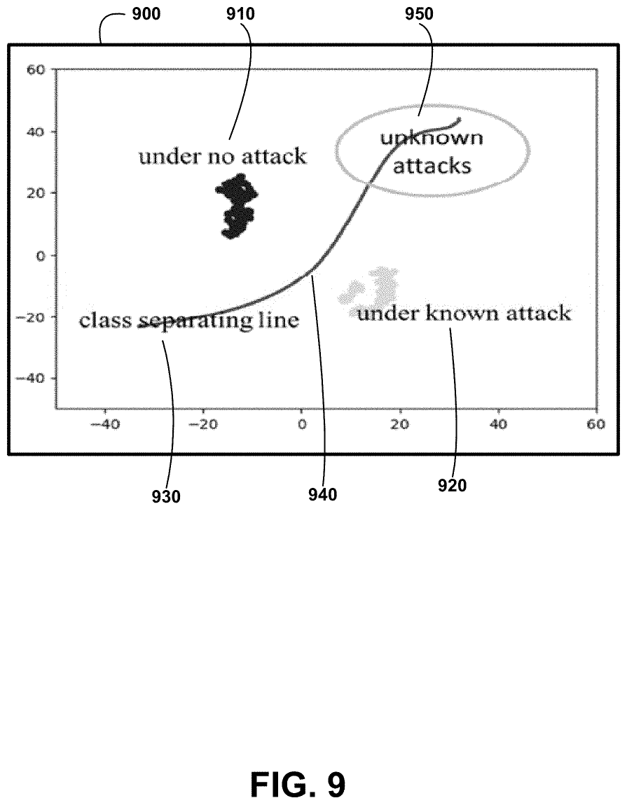

FIG. 9 shows for illustrative purposes only an example of a t-SNE plot for a user under no attack and a user under known attacks of one embodiment. FIG. 9 shows t-distributed Stochastic Neighbor Embedding (t-SNE) plot for a user under no attack and a user under known attacks 900. t-SNE is called nonlinear dimensionality reduction that allows separating data that cannot be separated by any straight line. ML classifiers use the HPC data to classify activities as under no attack 910 and under-known attack 920 using datasets. FIG. 9 shows a class separating line 930 illustrated with the curving class separating line 940. Unknown attacks 950 also referred herein as zero-day attacks are those activities not fitting to any current datasets.

Classifying unknown datasets as a user under no attack and an under-known attacks temporal sequences are plotted using t-SNE algorithm. It can be observed that under no attack and under-known attacks samples can be easily separated. In addition, to conduct binary classification, prior classification models which are trained with under no attacks and under known attacks dataset construct a line that separates samples into two classes. However, unknown attacks might locate on both sides of the line, which results in the misleading and accuracy degradation of the ML classifiers. As a result, to achieve a high detection accuracy, a classification line is constructed, as shown in FIG. 9, which defines the threshold of “under no attack” and any samples outside the line are classified as “under attack” of one embodiment.

### t-SNE Plot with the Desired Classifying Line for a User Under No Attack, Known Attack, and Unknown Attack Samples

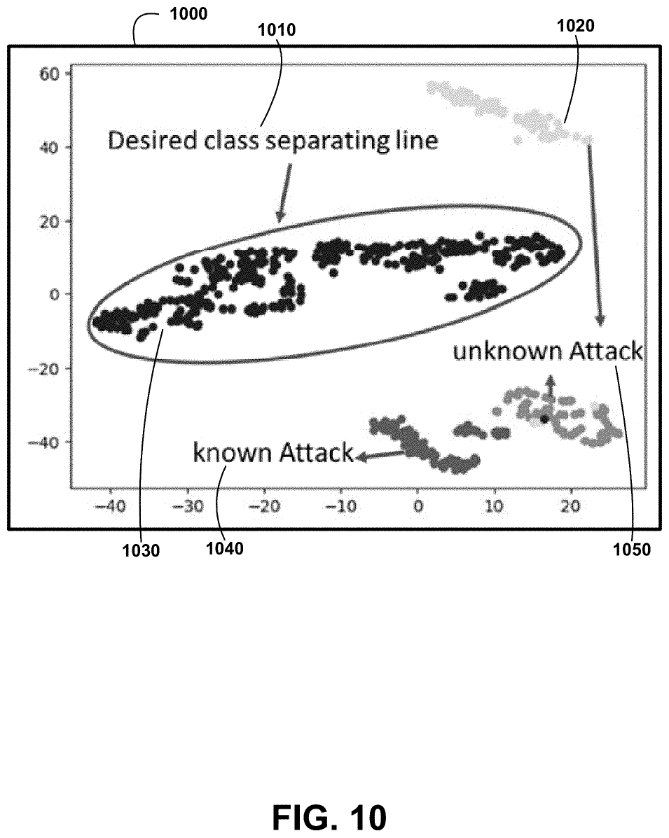

FIG. 10 shows for illustrative purposes only an example of a t-SNE plot with the desired classifying line for a user under no attack, known attack, and unknown attack samples of one embodiment. FIG. 10 shows a t-SNE plot with the desired classifying line for a user under no attack, known attack, and unknown attack samples 1000. The desired class separating line 1010 encloses the no attacks 1030 hits. A data distribution model includes a t-distributed Stochastic Neighbor Embedding plot that is calculated into desired classifying lines that encloses no attacks hits, wherein the non-linear desired classifying lines form thresholds the distribution detector calculates threshold values to distinguish the data to identify known attack, and unknown attack from false positive no attack data values.

Unknown attack hits 1050 and the unknown attack hits 1020 are separated by the positive and negative values produced by each. Known attack 1040 hits are identified and reported of one embodiment.

Classifying an unknown dataset includes user under no attack and user under known attacks temporal sequences. The temporal sequences are plotted using a t-distributed stochastic neighbor embedding (t-SNE) algorithm. A t-distributed stochastic neighbor embedding (t-SNE) is a statistical method for visualizing high-dimensional data by giving each datapoint a location in a two or three-dimensional map. It can be observed on the t-SNE plots that under no attack and under-known attacks samples can be easily separated.

In addition, to conduct binary classification, prior classification models which are trained with under no attacks and under-known attacks dataset could construct a line that separates the temporal sequence samples into two classes. However, unknown attacks might locate on both sides of the line, which results in the misleading and accuracy degradation of the ML classifiers. To achieve a high detection accuracy, constructing a classification line that defines the threshold of “under no attack” and any samples outside the line is classified as “under attack” of one embodiment.

### Different Threshold Influences User Under No Attack Distances and User Under Attack Distances

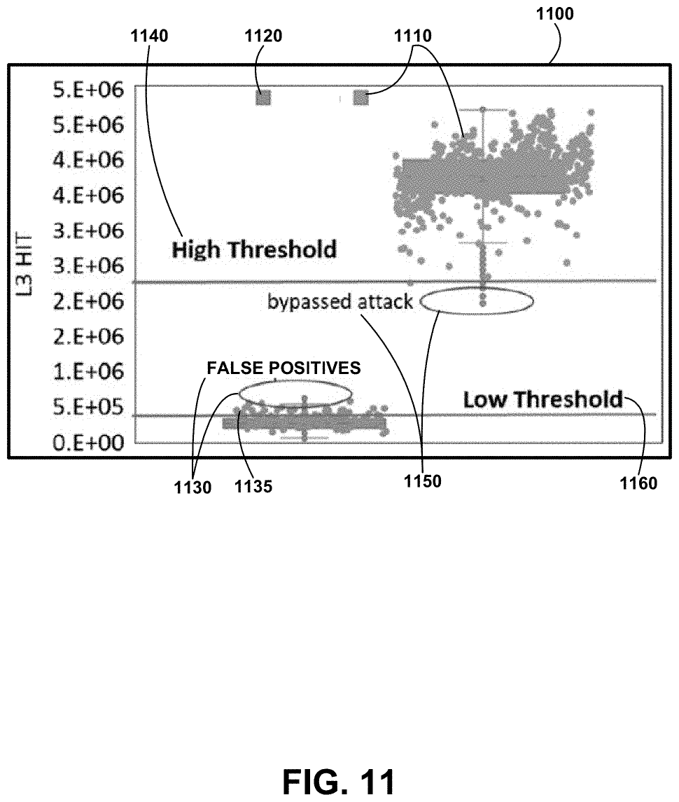

FIG. 11 shows for illustrative purposes only an example of different threshold influences of one embodiment. FIG. 11 shows different threshold influences: user under no attack distances and user under attack distances 1100. The two distances calculated are when user applications are under no attack and attack referred to as User under No Attack Distance and User under Attack Distances. User under Attack Distances 1110 have values above a high threshold 1140. As seen in FIG. 11 a few qualify as a bypassed attack 1150. The User under No Attack Distance 1120 contains false positives 1130 and positive hits 1135 values around a low threshold 1160 value of one embodiment.

The Gaussian distribution of HPCs temporal traces' distance values can estimate the percentage of points with a larger distance value than a certain threshold, which is a false positive rate. For example the percentage of points with a value larger than 10%. The theoretical false positive rate threshold is 10%. Different thresholds that influence the final prediction result are determined. The details of different thresholds are based on the HPC choice. The smaller the threshold is, the higher the theoretical false positive rate is, and the larger the threshold is, the higher the possibility of missing “under attack” detection. Choosing an optimal value to meet the false positive rate requirement and maintain high “under attack” detection accuracy at the same time is determined. For example, an optimal value as a threshold for the theoretical false positive rate is considered as 0.001 of one embodiment.

### Data Distribution, Gaussian Distribution, and Poisson Distribution of Various HPCs Temporal Traces

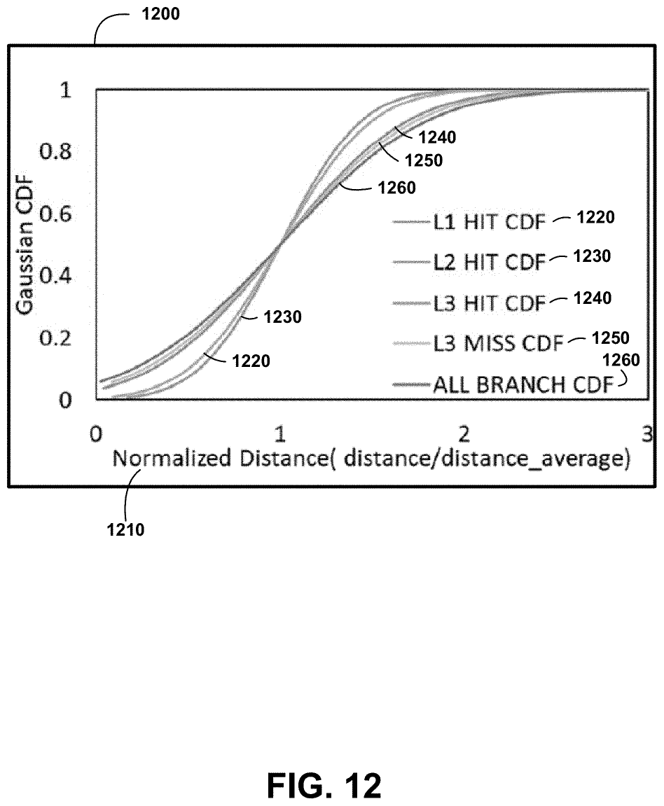

FIG. 12 shows for illustrative purposes only an example of the data distribution, Gaussian distribution, and Poisson distribution of various HPCs temporal traces of one embodiment. FIG. 12 shows data distribution, Gaussian distribution, and Poisson distribution of various HPCs temporal traces 1200. The Cumulative Distribution Function (CDF) traces are plotted using a normalized distance (distance/distance average) 1210.

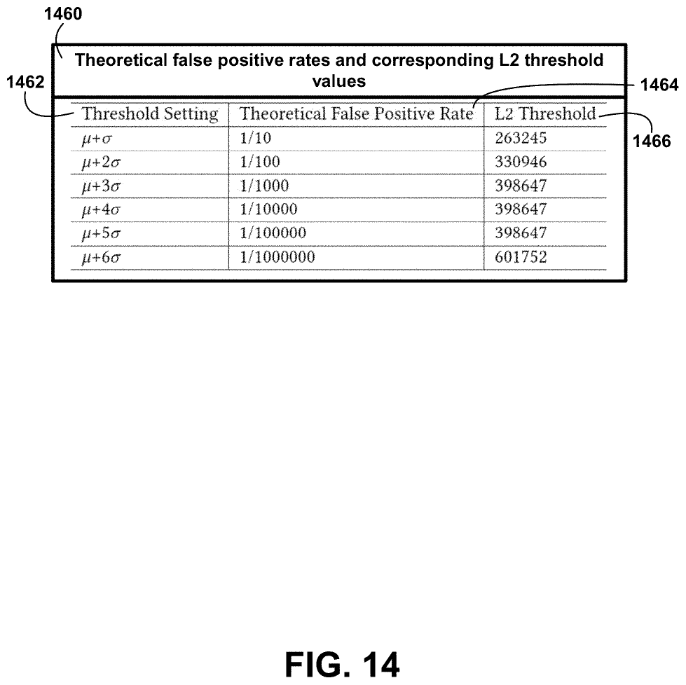

FIG. 12 shows a plotting for L1 HIT CDF 1220, L2 HIT CDF 1230, L3 HIT CDF 1240, L3 MISS CDF 1250, and ALL BRANCH CDF 1260 for branch predictor units. The data distribution, Gaussian distribution, and Poisson distribution of HPCs temporal traces' distance value can estimate the percentage of points with a larger distance value than a certain threshold, which is a false positive rate, for example, the percentage of points with a value larger than 10%. Hence, the theoretical false positive rate is 10%. Different thresholds influence the final prediction result. The details of different thresholds are listed in FIG. 14 based on the HPC choice of L2 HIT of one embodiment.

### Table 13: False Positive and False Negative Evaluation

FIG. 13 shows for illustrative purposes only an example of Table 13: False Positive and False Negative Evaluation of one embodiment. FIG. 13 shows Table 13 1300. Table 13 1300 shows classification results that are typical for predicted true (interval) 1310, predicted false (interval) 1320, predicted true (instance) 1330, and predicted false (instance) 1340. The user under no attack condition requires all the captured HPCs intervals to be classified correctly by the machine learning detector to achieve a correct prediction while the user under attack condition refers to the case that requires only one interval classified correctly to achieve a correct prediction. The results are identified as actual true 1350 and actual false 1360. Results possible include true positive, false negative, false positive, true negative, missed alarm, false alarm, and true alarm of one embodiment.

Each run of a user application is called an instance. For the purpose of real-time SCA detection, a certain window size is used to decide the number of samples an interval contains. Each instance could contain multiple intervals. In addition, a user application under no attack instance is divided into multiple intervals.

The first layer detector uses interval level results to estimate the highest value of false alarm rate once classifiers are trained. Suppose the number of intervals of an instance is N, the false positive rate is m %. The highest false alarm rate is when false positives are distributed evenly and FAR represents a false alarm rate. As a result, the highest possible false alarm rate is FAR_MAX. Two evaluation measures to reduce the level of FAR include 1) reducing false positive rate, and 2) delaying “under attack” decision until several consecutive intervals are predicted as “under attack”, gaining more confidence before reporting “under attack” of one embodiment.

### Theoretical False Positive Rates

FIG. 14 shows a block diagram of an overview of theoretical false-positive rates of one embodiment. FIG. 14 shows the theoretical false positive rate and corresponding L2 threshold value 1460. FIG. 14 shows in three columns a threshold setting 1462 with a corresponding theoretical false positive rate 1464 and L2 threshold 1466 value. After choosing the most suitable HPC feature, the threshold needs to be set. To achieve a high detection accuracy, a classification line is constructed which defines the threshold of “under no attack” and any samples outside the line are classified as “under attack”.

The two-layer detector contains two major parts: a) data collection, b) distance threshold determination (T) with dynamic time warping and data distribution, Gaussian distribution, and Poisson distribution, and online prediction with a threshold (T). The distribution processes are utilized for Threshold Determination. The data distribution, Gaussian distribution, and Poisson distribution of HPCs temporal traces' distance value can estimate the percentage of points with a larger distance value than a certain threshold, which is a false positive rate. Different thresholds influence the final prediction result. The 2nd Layer Detector is used to detect the known and unknown side-channel attacks of one embodiment.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
utilizing a plurality of machine learning classifier predictive models within a side-channel attack detection framework on a user's computer with a predetermined performance overhead;
training and testing the plurality of machine learning classifier predictive models;
collecting data from the user's computer with a data detector coupled to the side-channel attack detection framework for detecting known side-channel attacks;
calculating non-linear desired classifying lines to form thresholds to distinguish the data to identify known attack, and unknown attack from false positive no attack data; and
determining a data distribution model from the user computer data detector collected data with a distribution detector coupled to the side-channel attack detection framework for detecting both known and unknown emerging side-channel attacks.

2. The method of claim 1, further comprising determining an impact of a false positive rate at the interval level on the side-channel attack detection using an examining device.

3. The method of claim 1, further comprising setting a threshold of attack similarities based on an optimal false alarm rate based on a data distribution module.

4. The method of claim 1, further comprising determining and setting a target threshold value for reducing a false alarm rate using a processor.

5. The method of claim 1, further comprising reducing the instance level false positive rate with a false alarm minimization module.

6. The method of claim 1, further comprising calculating with dynamic time warping the similarities of user applications under no attack and user applications under attack hardware traces.

7. The method of claim 1, further comprising creating a data distribution model with dynamic time warping time-series classification to calculate collected data for a t-distributed stochastic neighbor embedding plot that creates desired classifying lines that encloses no attacks hits, wherein the non-linear desired classifying lines form thresholds to distinguish the data to identify known attack, and unknown attack from false positive no attack data.

8. The method of claim 1, further comprising monitoring activity of the user computer microarchitectural features including collecting activity data from processors' hardware.

9. The method of claim 1, further comprising training using collected trace data machine learning classifiers predictive models.

10. The method of claim 1, further comprising testing using collected trace data machine learning classifiers predictive models.

11. An apparatus, comprising:
a side-channel attack detection framework comprising a data detector and a distribution detector configured for detecting known and unknown side-channel attack on a user's computer;
a data detector configured for constantly monitoring the user's computer microarchitectural features activities in real-time;
wherein the data detector includes a machine learning-based classification system; and
a distribution detector data distribution model configured for detecting both known and unknown emerging side-channel attacks in real-time.

12. The apparatus of claim 11, further comprising the data detector is configured to collect user computer hardware data in real-time to protect the user's computer from side-channel attacks.

13. The apparatus of claim 11, further comprising the side-channel attack detection framework is configured to operate a low-cost security countermeasure system that identifies known and zero-day side-channel attacks with a minor performance overhead.

14. The apparatus of claim 11, further comprising the data detector is configured for constantly monitoring the user's computer microarchitectural features activities including collecting activity data from the user's computer processors' hardware.

15. The apparatus of claim 11, further comprising data detector training and testing modules coupled to the machine learning-based classification system and configured for training and testing machine learning classifiers predictive models.

16. An apparatus, comprising:
a side-channel attack detection framework consisting of at least one data detector and a distribution detector to detect known and zero-day side-channel attacks on a user's computer;
at least one data detector module coupled to the side-channel attack detection framework configured to constantly monitor and collect data from the user's computer microarchitectural features activities;
at least one data detector module coupled to the side-channel attack detection framework is configured to train and test machine learning classifiers predictive models; and
a distribution detector coupled to the side-channel attack detection framework configured to create at least one data distribution model to detect both known and unknown emerging side-channel attack s in real-time.

17. The apparatus of claim 16, further comprising the at least one data detector module configured to train machine learning classifiers predictive models using collected hardware trace data.

18. The apparatus of claim 16, further comprising the side-channel attack detection framework configured to achieve detection of side-channel attack s in real-time with a minor performance overhead and the capability to capture zero-day attacks.

19. The apparatus of claim 16, further comprising the at least one data detector module configured to test machine learning classifiers predictive models using collected hardware trace data.

20. The apparatus of claim 16, further comprising the distribution detector configured to create at least one data distribution model to set a threshold to identify under no attack and under attack traces.
